(19) United States
(12) Patent Application Publication
(10) Pub. No.: US 2021/0368731 A1
(43) Pub. Date: Dec. 2, 2021

(54) PORTABLE, WASTE MANAGEMENT SYSTEM AND METHOD FOR TEMPORARY ANIMAL ENCLOSURES

(71) Applicant: Michael Holman, Payson, UT (US)

(72) Inventor: Michael Holman, Payson, UT (US)

(21) Appl. No.: 17/237,413

(22) Filed: Apr. 22, 2021

Related U.S. Application Data
(60) Provisional application No. 63/032,126, filed on May 29, 2020.

(51) Int. Cl. A01K 1/01

(52) U.S. Cl. CPC A01K 1/0135; A01K 1/0103

(57) ABSTRACT

A portable waste-collection system fits under a temporary enclosure or inside a permanent enclosure at a venue engaged for a temporary event, such as a fair, rodeo, animal show, or the like. A frame, deck, rollers, and motor drive a movable layer, such as belt supported on a frame and deck. Collected waste and bedding is carried out of the pen into a drain conduit and solids conveyor. Sanitizing spray washes, rinses, and sanitizes before draining out across a drain board into the conduit. A temporary holding subsystem may segregate solids and liquids, but contains them for hauling or discharging to a suitable waste processing destination.

### BACKGROUND

### Related Applications

This patent application claims the benefit of U.S. Provisional Patent Application Ser. No. 63/032,126, filed on May 29, 2020, entitled PORTABLE, MAINTENANCE SYSTEM AND METHOD FOR TEMPORARY ANIMAL ENCLOSURES, and hereby incorporates herein by reference U.S. Pat. Nos. 7,614,365; 3,119,374; 9,271,472; 2,988,204; 1,551,221; 1,444,119; 1,366,384; 474,559; 442,064 and European Patent Nos EP1,848,266 and EP2,979,541.

### Field of the Invention

This invention relates to animal enclosures and, more particularly, to novel systems and methods for maintaining cleanliness by removing wastes therefrom.

### Background Art

Farms, ranches, arenas, workout facilities, rodeo grounds, fairgrounds, and so forth have periodic but temporary occupancy of pens or enclosures for animals. Animals, such as at fairs, shows, and the like may range from small pets to large agriculture animals, horses, cattle, and the like. Waste management is always an issue to deal with.

For example, animals in temporary enclosures may be outdoors, indoors, or may spend time in both locations for reasons of management, movement, health, events and so forth. Typically, clean up must either be individual or await removal of temporary enclosures or fences to permit bulk, machine-supported cleaning.

Otherwise, such as in the case of an event that may occupy days, such as a fair lasting weeks, cleaning pens or enclosures of animals may be a daily or otherwise regular task for owners of an animal. Such cleanup of solid and liquid wastes as well as bedding materials typically strewn on the floor of such enclosures may create difficulties, potential problems with sanitation, undesirable smells, other results of bacterial action over time, and the like.

It would be an advance in the art to provide a modular system capable of fitting under one or more pens or enclosures to automatically handle solid waste, liquid waste, bedding, and so forth. it would be a further advantage to provide a system in which individual pens may be identified for cleaning, while others, unoccupied or seldom used, may be left in the system but not actively cleaned when unnecessary.

It would be a further advance if waste could be removed with a minimum of human intervention, and collected into suitable storage facilities for hauling to a remote disposal site, such as a farm, a waste facility, or another location where the recycled materials are useful rather than simply a burden and disposal hazard.

BRIEF SUMMARY OF THE INVENTION

In view of the foregoing, in accordance with the invention as embodied and broadly described herein, a system may include various subsystems, including an enclosure itself, which may or may not be part of the system. That is, an enclosure may be in place already, or brought in for an event, and need not be a part of the cleaning maintenance system. Nevertheless, in use, the system has an ability to maintain and regularly clean pens hosting an animal or multiple animals.

A collection subsystem may include frames, motive means such as motors and rollers, driving a movable top layer. Supported on a frame and deck, the movable top player is also capable of relative motion to move any collected liquid or solid waste or bedding out of the pen and toward a handling device appropriate to the material being cleaned out of the pen.

A sanitizing subsystem may spray, sanitize, rinse, and otherwise remove small particles, entrained liquids, and other materials, sweeping such cleaning or sanitizing liquids into the waste system for disposal. To that end, a holding subsystem may segregate solid waste materials from liquid waste before hauling or discharging each to a suitable waste processing destination.

An enclosure will have some member operable as a gate for admitting or introducing an animal into the enclosure, forming a part of the basic fence. The fence may be temporary or permanent. The fence, on the one hand will typically be fixed with respect to a supporting surface, such as a concrete pad or directly to the ground. It is possible that the underlying surface may be a deck of a trailer or truck for transport of the enclosure, the system, the animal, or any combination of the above.

A surrounding frame of the system will typically extend on all sides, with any necessary angle or cross bracing as needed to rigidize itself and stabilize the collection subsystem. Typically, a nearly solid deck, although it should have dimensional stability, will typically be perforated by apertures, yet provide support under a belt as a top surface capable of moving. In some embodiments, the belt may move with an animal or animals on the belt in the pen. In other embodiments, animals may be removed from the pen in order to use less power, and to more efficiently rely on the belt to carry waste products out of the enclosure.

A standing surface on top of a belt may be formed of a different material than the belt, may be formed as texturing of the belt, may involve certain treatments of the belt, such as by sand, fabric, mats, or the like Likewise, texturing and molding an upper surface of the belt may render the standing surface to have suitable mechanical properties including proper friction against feet or hooves of an animal on the belt.

The belt may be driven to slide or move with respect to the deck, which is fixed to the frame. To that end, a drive roller near the back of a pen (enclosure), where the waste handling conduits and channels are, seems to work best. Meanwhile, at an opposite (front, nearest the gate) end, an idler such as a tension idler or tail roller may maintain tension in the belt, so the drive roller can move the belt efficiently, and reliably. A motor having a suitable transmission for change of speed, direction, or both may connect to the drive roller to provide a motive means for rotating the drive roller and advancing or reciprocating the belt for cleaning.

Below any standing surface, belt, deck, and the like will typically be a drain board or pan for draining any liquids that may pass from the belt or through the belt and deck.

A sanitizing system may include a sprayer and lines powered by a pump and controlled by valves. Typically, some type of a sanitizing agent, detergent, organic surfactant, or the like may be included in a sanitizer tank. A rinse liquid may be contained in a rinse tank and may or may not also be treated with a final sanitizing chemical. Certain agricultural industries have specific, approved, sanitizing liquids or soluble sanitizing solids that may dissolve in water or other liquids to provide a sanitizer. Such may be selected to biodegrade in a short time, such as several days in the presence of soil, air, or both. Typically, water, chlorinated water, or the like may serve as a rinse. Other chemicals used for treating insect infestations, other animal hygiene functions, or the like may be added to the main cleaner or sanitizer, or to the rinse.

Typically, it is contemplated that multiple rinses may be used including a power rinse under comparatively high pressure (hundreds or thousands of psi) to either drive or rinse out the main sanitizer, while leaving some portion thereof behind. In other embodiments, the cleaning may actually be done by a rinse containing detergents and the like, which are then themselves replaced by a sanitizing liquid as a rinse containing a chemical, which is left to dry.

Sprayers may spray manually or from fixed positions under the belt, over the belt, or both as deemed appropriate. Pump volumes, pressurized liquids, and materials may be suited for durability, longevity, the chemical environment, and so forth.

Solid materials may be carried by a conveyer, once dropped into a tray at least partially enclosing such a conveyer. Conveyors typically include a moving belt or chain carrying scrapers, etc. In other embodiments, one may think of a tray as being a part of a conveyer, a non-moving portion. Meanwhile, liquids may be carried away by a gutter, ditch, channel, line, pipe, or the like. Thus, the liquids may be moved toward a storage tank, while solids are conveyed to a solid waste bin. To the extent necessary, liquids may be pumped by a suitable pump mechanism, whether an eductor, impeller, paddle, or the like as needed or appropriate to move liquids to the storage tank. Likewise, the paddles, vanes, blades, scrapers, scoops, or the like along a flexible mover or carrier, such as a link belt or the like may push solids along a tray of a conveyer.

In certain embodiments, a scrubber may be appropriate to mechanically separate solid materials from the standing (uppermost) surface on a belt. For example, solids may be randomly pushed into textures, compacted into channels, forced into drain apertures, or the like. Accordingly, a scrubber system may include a scraper operating close to or against the standing surface of a belt in order to scrape off solids as best as reasonable. For example, a metal blade, a squeegee type of rubber blade, or the like may remove solids.

Likewise, a brush such as a rotating brush having suitably stiff bristles may also brush the standing surface of a belt in order to dislodge solid materials that may be adhering to or trapped in a standing surface or texturing of a belt. To that end, brushes may be multiple, and may have different types of bristles, as well as different sizes and different movement paths. Brushes, it has been found, often agitate and dislodge solids from crevices, corners, fabrics, nap, or the like much better than a solid scraper. On the other hand, solid scrapers tend to force bulk materials to force uniformity and dislodge from comparatively smoother surfaces. By either means, textured or channeled surfaces may be addressed by specially shaped (contoured; profiled edge) scrapers, suitably stiff and conforming, bristled brushes, or the like.

Typically, a certain amount of relief between a deck and a moving belt, or movable belt, sitting on top of that deck may require a frictional dissociation, or even a gap. In some embodiments, it may be valuable to coat a deck with a low-friction material. For example, high density polyethylene (HDPE) has been found to be a durable material having a comparatively low coefficient of friction with many materials including metals, certain polymers or elastomeric materials, and fabrics. Thus, a deck may be coated or may be layered with (fastened to) such a material to improve (reduce) frictional interaction between a deck, and the movable belt resting thereagainst.

In some embodiments, the belt may be continuous or an infinite loop. This is sometimes called a continuous loop or infinite loop. In other embodiments, cables, such as straps, ties, polymer ribbons, or the like may connect to a belt that only operates on top of its framing system, in order that the passage of liquids through, or otherwise off, the belt and to the drain board therebelow may be less obstructed.

For example, a take-up reel may allow a reciprocating belt that is clamped to the principal top belt. Thereby, the portion of the belt passing under the standing surface may be emptied, and may then be either advanced or reciprocated back into place. In other embodiments, a belt that only passes over the top deck and around the rollers may be secured by straps or wire cables to complete an infinite loop. Such a configuration can only serve when properly positioned on the deck to receive bedding and collect waste materials.

In one alternative embodiment, sprockets matching apertures in the belt, or having teeth matching apertures in the belt, may drive the belts. In other embodiments, the drive roller and tension roller may be toothed to match a toothed belt.

By whatever means, a belt will typically include an elastomeric, flexible layer in order to provide sufficient flexibility perpendicular to its surface in order to be able to pass around the rollers. The belt provides flexibility for animals standing thereon, certain stress relief, not available on a hard, rigidly solid (e.g., concrete, steel) floor or deck.

Typically contemplated is an elastomeric material formed in one or more layers having an embedded mesh therewithin for structural strength, dimensional stability, and stable operation around the rollers. That is, elastomeric materials are by their physical properties quite flexible. However, stability for operation as an uninterrupted loop or infinite loop (belt) around a drive roller and idler roller will be stabilized by a metal or other comparatively inextensible fiber therewithin. This configuration better serves in practice, as tested in an apparatus in accordance with the invention.

Apertures may be formed in the deck and belt, and a standing surface if it is formed of a material different from that of the belt. That is, a standing surface may be a mat or the like of a different material having better frictional properties than, for example, a smooth, elastomeric top layer of the belt. Thus, apertures may drain through the belt while in use, and down through perforations in a deck.

In certain embodiments, the belt may be channeled or may have a channeled standing surface having lands and grooves. Thus, grooves or channels may pass liquids on a slight (non-zero to five percent slope) angle toward the back collection edge of the system, while the solid materials will remain on the standing surface of the belt.

Ultimately, channels with or without cross channels in the standing surface, the belt, or both may carry liquids n directions and to locations where they may be received and conducted away. For example, if a surface is simply textured rather than covered with a different material, then the texture may provide improved traction or friction between feet or hooves of an animal and the belt, as well as providing an immediate escape for liquids away from the highest points of texturing, and thereby render the highest surfaces dryer.

In certain embodiments, the lands or protrusions, separated by channels, cross channels, or both, may actually provide a certain amount of frictional resistance to sliding, simply by the fact of geometry. For example, within a gap, between adjacent lands, in any direction, the weight of an animal will compress one land, while a hoof will be stopped against lateral motion perpendicular to the vertical by virtue of an adjacent, non-compressed land.

In retrieving (separating) solids from the belt and its standing surface, a blade, squeegee, brush, or combination may be urged by a spring or other bias mechanism to press a comparatively conformal, narrowest, or both edge thereof against the standing surface of the belt. Accordingly, a suitable mount thereof may be pivotable in order to respond to a bias to allow the blade, brush, or squeegee to ride on the standing surface of the belt as it passes by on a drive roller. Meanwhile, the drive roller serves as an anvil to hold the belt firmly while the blade or squeegee blade, brush, scrapes or abrades solid materials away from the belt.

With respect to the drain board, a drip edge at a rear edge of the drain board may provide a path for liquids to securely and without splashing drain into a gutter to be carried away. Likewise, the drain board may also have a floor reinforced by corrugations to improve handling and mechanical or dimensional stability (rectangularity, stiffness, maintaining shape, etc.). A back wall may add stiffness and control splashing as a boundary opposite the drip edge.

Side walls may actually be formed to be interleaving or overlapping such that they will shed any liquid falling on them, and direct it to one side or the other of that side wall. In this way, the actual drain board may be formed as a set of drain boards that quickly interleave together in order to cover a broader expanse. Thus, much like roofing, the drain board may be formed in comparatively longer and narrower expanses, which can then be interleaved on their long sides to make a larger expanse in both their longitudinal and lateral (sideways) dimensions.

A method may include providing an enclosure, readily transportable, erectable, and removable, as a temporary structure confining an animal, the enclosure supportable independently on a supporting surface; providing a frame fitted to the enclosure and supportable independently on the supporting surface; providing a deck supported by the frame; providing a surface, selectively movable horizontally with respect to the deck and supported thereby in a vertical direction.

The method may include providing a transport structure proximate the enclosure having a mechanism effective to receive from the surface, and carry to a container for temporary storage, solids and liquids received from the surface upon movement of the surface with respect to the deck. Then the method extends to selecting a first location; positioning the enclosure, frame, deck, surface, and transport structure on the supporting surface at the location; and placing an animal within the enclosure. Eventually or periodically the method may extend to discharging solid materials from the surface by moving the surface toward the transport structure; and removing the frame, deck, surface, and transport structure from the first location.

The method may include relocating the frame, deck, surface, and transport structure to a second location remote from the first location. It may comprise removing a storage bin receiving from the transport structure solid waste, such as by way of a drain pan under the surface, shaped to collect and drain the liquids from the surface toward the transport structure. A removable storage tank may receive therein the liquids received from the surface and drain pan.

Dislodging solid materials from the surface, by moving the surface horizontally toward the transport structure and immediately away therefrom, is aided by inverting the surface before moving it immediately away from the transport structure. This removes bedding materials selected and placed for the animal.

A motor and controller, operably connected to move the surface, may operate the surface as an endless belt. A drive roller operably connected to drive the endless belt may be driven by the motor. A scraper is operably positioned to dislodge a portion of the material from the surface. Dislodging another portion of the material from the surface is accomplished by washing the surface with a washing liquid.

An apparatus operating in accordance with the invention may include an enclosure, readily transportable, erectable, and removable, as a temporary structure confining an animal, the enclosure supportable independently on a supporting surface; a frame fitted to the enclosure and supportable independently on the supporting surface; a deck supported by the frame; a surface, selectively movable horizontally with respect to the deck and supported thereby in a vertical direction. It may include a transport structure proximate the enclosure having a mechanism effective to receive from the surface, and carry to a container for temporary storage, solids and liquids received from the surface upon movement of the surface with respect to the deck; and storage operably and temporarily connectable and disconnectable, selectively, to the transport structure to receive therefrom the solids and liquids.

It may include a drain pan under the surface, shaped to collect and drain the liquids from the surface toward the transport structure. Storage may comprise a storage tank receiving therein the liquids received from the surface and drain pan. A dislodging device dislodges at least a portion of the solids from the surface by moving the surface horizontally toward the transport structure.

A roller may invert the surface before moving it immediately away from the transport structure. A motor and controller are operably connected to move the roller. The surface may be configured as an endless belt. A scraper operably positioned will dislodge a portion of the material from the surface, and a washing system is operably connected to wash the surface with a washing liquid.

One embodiment of a method comprises providing an enclosure, readily transportable, erectable, and removable, as a temporary structure confining an animal, the enclosure supportable independently on a supporting surface. It provides a frame fitted to the enclosure and supportable independently on the supporting surface, a deck supported by the frame, a belt operably movable by a roller to be selectively movable horizontally with respect to the deck and supported thereby in a vertical direction, and a drain pan under the surface to receive liquids.

A transport structure proximate the enclosure has a mechanism to receive from the surface, and carry to a temporary storage location, solids and the liquids received from the surface during movement of the belt. After selecting a first location, the method positions the enclosure, frame, deck, surface, and transport structure on the supporting surface at that location One may place bedding, such as wood chips or shaving, and an animal within the enclosure. Discharging all solid materials from the surface is accomplished by moving (rolling, scrolling, sliding) the surface toward the transport subsystem.

The frame, deck, surface, and transport structure may all be removed from the first location after use. One may transport and relocate the frame, deck, surface, and transport structure to a second location, remote from the first and operate the method.

A motor and controller may operably connect to move the belt surface as an endless belt on a drive roller carrying waste and bedding materials to a storage bin, storage tank, or both, which may also remove from the first location. Dislodging solid materials from the surface, by moving and inverting it may be augmented by a scraper washing liquid, or both.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is schematic block diagram of one embodiment of and method for cleaning portable enclosures for animals in accordance with the invention;

FIG. 2 is an upper, frontal, perspective view of one embodiment of a system in accordance with the invention;

FIG. 3 is a top plan view thereof;

FIG. 4 is a front elevation view thereof;

FIG. 5 is a partially cut away, upper, perspective view of selected components thereof, illustrating schematically multiple, optional embodiments of a supporting deck;

FIG. 6 is a top plan view of one embodiment thereof;

FIG. 7 is an upper, rear, perspective view of one embodiment of a system in accordance with the invention;

FIG. 8 is a side, elevation, perspective, cross-sectional view of one embodiment of a belt passing along a deck supported by tubular beams in a frame of a system in accordance with the invention;

FIG. 9 is an exploded view of various options for belt and drive mechanisms in accordance with the invention;

FIG. 9A is a side, elevation view of an endless belt on a drive roller and tension idler;

FIG. 9B is a side, elevation view of an alternative embodiment of a reciprocating belt and cable take up system in accordance with the invention;

FIG. 9C is a belt and connector system operating about a drive roller and an idler capable of use as either an endless belt or reciprocating belt, providing a single layer for animal support on a deck;

FIG. 9D is a side, elevation view of an alternative embodiment of an endless belt driven by toothed sprockets, as drive roller and idler, advancing a perforated belt fitting over sprocket teeth;

FIG. 9E is a side, elevation view of an alternative embodiment of sprocketed drive and idler rollers relying on a toothed belt for engagement;

FIG. 10 is an exploded view of various options for belting and surfacing rollers on an apparatus in accordance with the invention;

FIG. 10A is a side, elevation, cross-sectional view of one embodiment of a belt reinforced with an interior mesh and covered by a different surface layer than the base material;

FIG. 10B is a partially cut away, perspective view of a cross section of one embodiment of a channeled mat having perforations as drains within the channels;

FIG. 10C is a perspective view showing a cross section of a portion of a belt relying on channels having lands therebetween textured for providing a more sure footing instead of a top mat or surface material;

FIG. 10D is a partially cut away, perspective view of one embodiment of a perforated mat that may include or not include a top surface material on an underlying structural, flexible, belt system;

FIG. 10E is a partially cut away, perspective view of an alternative embodiment of a channeled belt or mat including directional channels in the longitudinal direction of motion as well as cross channels communicating between the longitudinal channels, and which may include perforations or not;

FIG. 10F is a cut away view of one embodiment of a land of a belt having a textured upper surface to assure footing of an enclosed animal;

FIG. 10G is a cut away, perspective view of a small portion of a belt illustrating a channeled and cross-channeled pattern for a mat or belt in accordance with the invention, providing discontinuities for better footing, and drainage in any direction;

FIG. 10H is a cut away, perspective view of a small portion of a belt having an alternative, regular texturing on an upper surface thereof in order to assure footing, and provide drainage of liquids therefrom;

FIG. 11 is a cut away, side, elevation, cross-sectional view of one embodiment of a scraper and brush cleaner or scrubber for removing solid materials from a surface of a belt in an apparatus in accordance with the invention;

FIG. 12 is an upper, rear, perspective view of a drain board or pan underlying an animal containment subsystem and collection subsystem in accordance with the invention, to provide drainage into a gutter carrying away liquid waste; and

FIG. 13 is a cut away, upper, perspective view of a small portion of a drain board in accordance with the invention, illustrating an overlapping or interleaving wall at lateral (side) edges of adjacent modular segments of the drain board of FIG. 12.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of systems and methods in accordance with the invention. The illustrated embodiments will be best understood by reference to the drawings, wherein like parts are designated by like numerals throughout.

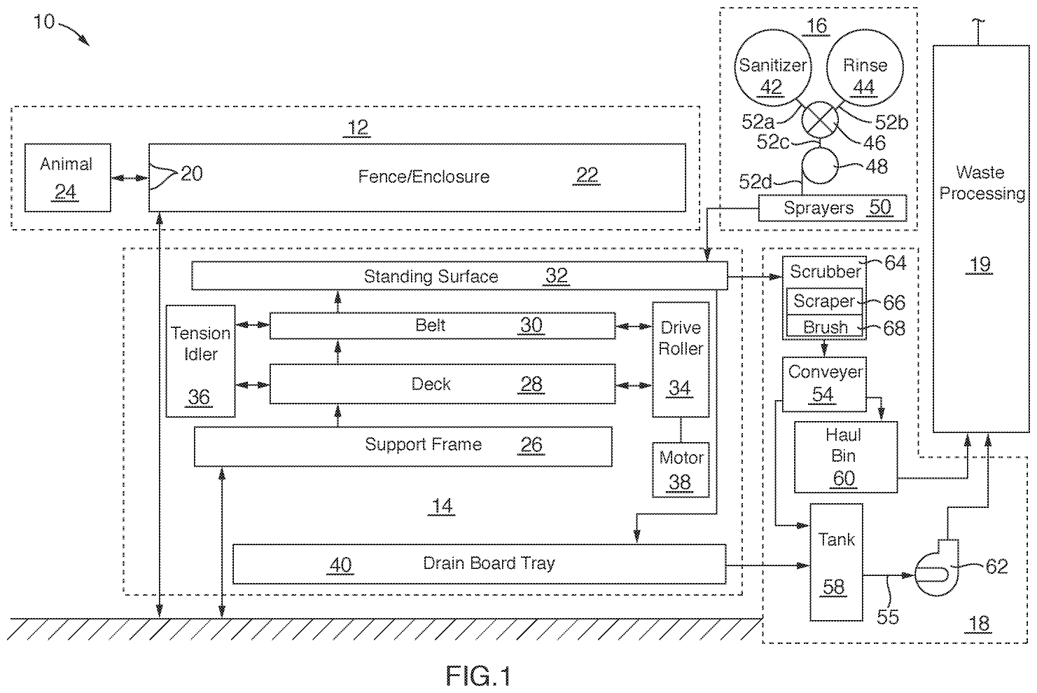

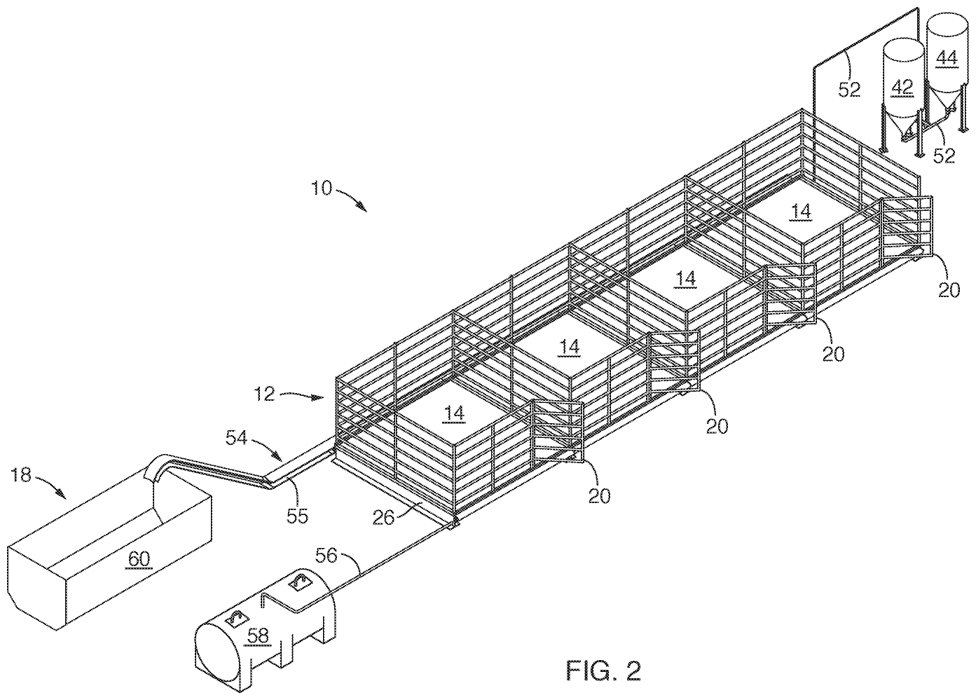

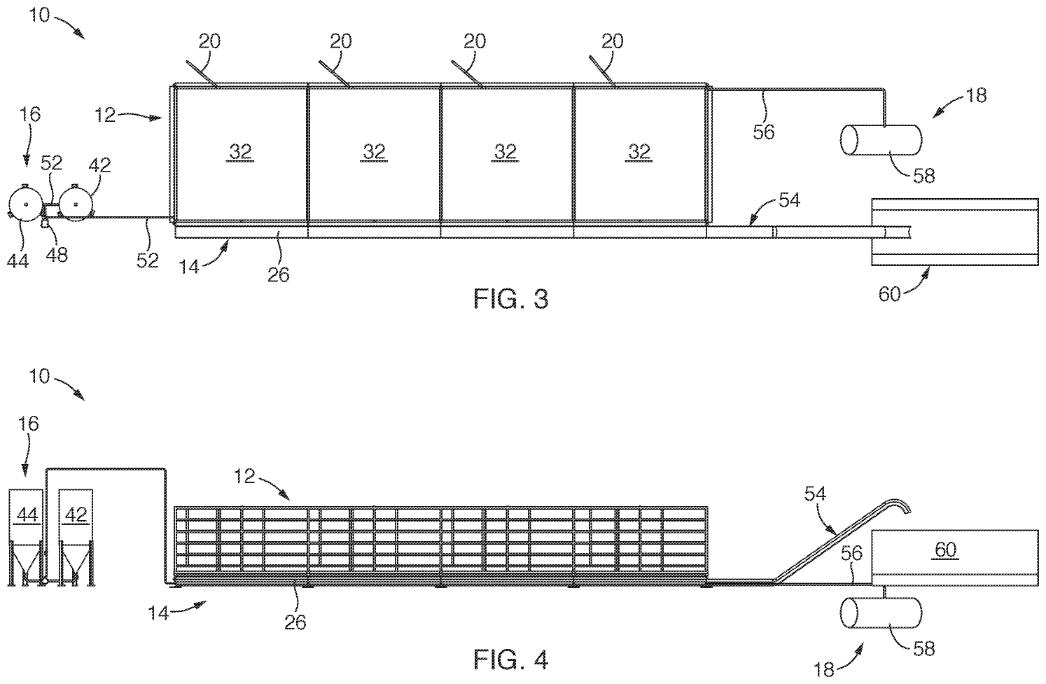

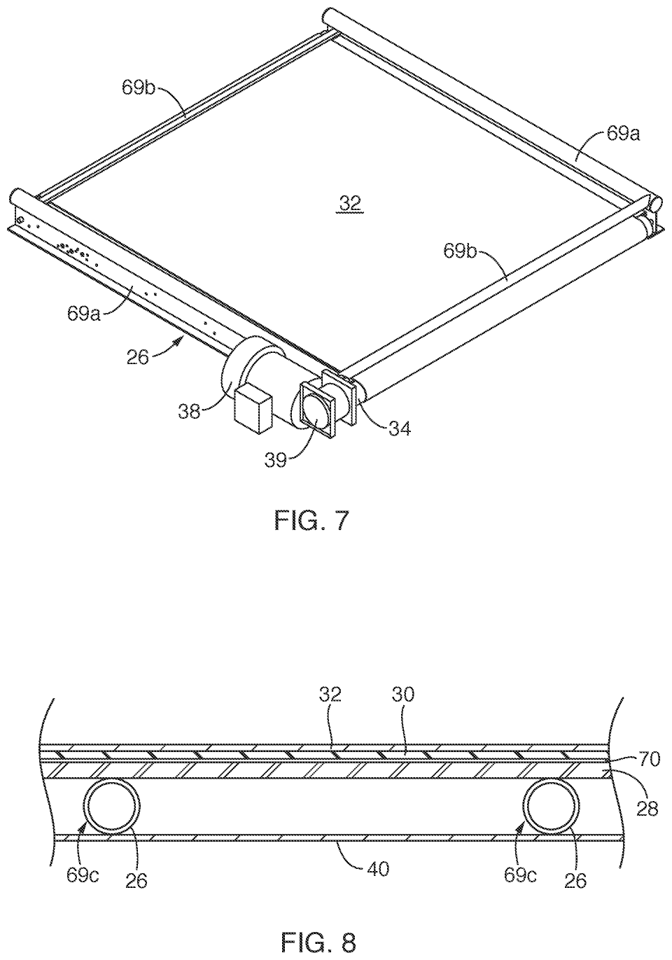

Referring to FIGS. 1 through 7 and FIGS. 1 through 13, generally, a system 10 in accordance with the invention may include an animal restraint or containment subsystem 12 such as an enclosure 12 adapted to contain, house, and restrain an animal 24. The enclosure 12 may typically be a temporary structure 12 such as may be used at a fair, rodeo, show, arena, or the like. In such circumstances, the enclosure 12 may be located on bare ground, concrete, or other supporting surface. Inasmuch as events are often held in venues not dedicated to a single purpose, complete removal of all traces of an animal-oriented event may be required. Facilities are typically removed in comparatively short order over a period of a day or two following an animal-oriented event.

Thus, an enclosure 12 may often be a temporary structure to be dismantled in its entirety. Meanwhile, animals 24 may include a variety of species. Typically, within an enclosure 12, one or more animals 24 may be provided with food, water, individual care, bedding materials, and so forth.

A collection subsystem 14 or collector 14 may be installed in an enclosure 12, acting as a floor structure 14 for the enclosure 12. The collection subsystem 14 is responsible for disposition of materials needing removal from within the enclosure 12 during an event. That is, often from a time before until sometime after an event, animals 24 may be kept in an enclosure 12. Periodically, a collection subsystem 14 may collect, remove, and redirect materials on or falling to the floor of an enclosure 12, represented by a portion of the collection subsystem 14 or collector 14.

A sanitizing subsystem 16 or sanitizer 16 may include multiple components suitable for cleaning the collection subsystem 14, which is itself cleaning the space within the enclosure 12. A sanitizer 16 may be responsible to mechanically, chemically, hydrologically, or otherwise remove bedding, animal wastes, liquids, spills, and the like from components of the collection subsystem 14. For example, surfaces may benefit from washing, scrubbing, rinsing, spraying, or the like. A sanitizing subsystem 16 may be responsible for any or all of such operations to minimize habitat for undesirable microbes or insects responsible for undesirable smells, disease, or the like.

A holding subsystem 18 may receive materials from the collection subsystem 14 and sanitizing subsystem 16. The holding subsystem 18 may typically segregate solid materials or those that represent primarily solid materials, while another portion of the holding subsystem 18 may receive, contain, secure, treat, or the like, liquid products. Liquid products may result from animal waste, cleaning liquids such as water and detergents, rinsing materials such as water and sanitizing additives, and so forth.

A waste processing subsystem 19 may or may not be a part of the system 10. For example, waste processing 19 may be conducted by an equipment suite 19 remote from an event, and thus the system 10. Ultimately, some type of waste processing 19 must be done, remotely from the system 10 at an event. After all, an event is often a temporary activity occurring at a venue not necessarily dedicated to that activity alone. For example, arenas, stadia, fairgrounds, conference centers and the like may host a different event every week or every few weeks with a regular periodicity. Thus, waste processing 19 or some portion thereof will involve disposition of solid and liquid materials at a location where they may be collected for bulk processing, such as composting, discharged into treatment plants, and so forth.

Thus, for example, a certain amount of waste processing 19 may involve chemical or digestive treatment processes. On the other hand, for millennia, farmers have recycled animal waste products on their fields as a soil amendment. Thus, waste processing 19 may be present and done as a subsystem 19 and a process 19 partially onsite at an event, and partially at a remote site. On the other hand, processing 19 may be taken completely out of the system 10, relying strictly on the holding subsystem 18 at and during an event.

In one currently contemplated embodiment, the enclosure 12 may include a gate 20 for admitting and discharging an animal 24. Animals 24 will need a gate 20 in order to be removed from the enclosure 12 for show, performance, comparison or judging, or the like. Meanwhile, the gate 20 admits the animal 24 initially, and confines the animal 24 until discharged.

In some instances, a gate 20 may be used to remove an animal 24 from an enclosure 12 temporarily in order to operate the collection subsystem 14, the sanitizing subsystem 16, or the like. Depending upon the particular animal 24 contained within a fence 22 and gate 20 of an enclosure 12, the collection subsystem 14 may operate with the animal 24 within the enclosure 12. That is, advancing the processes of the collection subsystem 14 need not be done in the absence of an animal 24 within the fence 22.

On the other hand, smaller gauges of steel and belts 30 may be suitable for constructing a collection subsystem 14 if large, and therefore heavy, animals 24 are removed during cleaning. Large cattle, and horses, or groups of animals 24, may be temporarily removed from within the fence 22, through the gate 20. Thus, only bedding materials and other waste need be supported and carried by the collection subsystem 14 while in motion, greatly reducing the need for power, strength of materials, and so forth.

With respect to the collection subsystem 14, a frame 26 may be installed, positioned, assembled, transported, or otherwise put in place to service a containment subsystem 12. In one currently contemplated embodiment, the frame 26 supports a deck 28 capable of supporting the weight of animals 24 within the enclosure 12.

A belt 30 moves along the deck 28 when the collection subsystem 14 is activated for removing waste from an enclosure 12. The belt 30 may have one surface 32 or a standing surface 32 as an outer surface 32 thereof. For example, texturing, a patterning in solid materials, a mat, a fabric material, grit, a fibrous or other frictional surface 32, or the like may be added to the belt 30, bonded to the belt 30, integrated within the belt 30, or otherwise attached to form a standing surface of the belt 30.

Typically, a standing surface 32 will provide a certain amount of relief (e.g., compression, resilience, etc.) under the feet, paws, or hooves of an animal 24. Likewise, a standing surface 32 may have another principal objective of providing frictional engagement by the feet, paws, or hooves of an animal 24. This provides secure footing on the standing surface 32, and the underlying belt 30.

This is perhaps of most significance when a belt 30 is formed of a comparatively stiff, comparatively hard, and comparatively smooth material. In such a situation, slight amounts of liquid, or simply moisture in solid waste may be sufficient to reduce friction causing an animal 24 to slip and fall. This can be a serious matter to be avoided. Thus, grit, fiber, texturing, irregular protrusions, and the like are all suitable materials for forming a standing surface 32 on a belt 30 in order to provide frictional engagement with the feet, paws, hooves, or the like of an animal 24.

The belt 30 may typically be driven by a drive roller 34 around which the belt 30 is threaded or reeved. Likewise, at an opposite end of the enclosure 12 a tension idler 36 or tail roller 36 may match the load support of the drive roller 34. Maintaining sufficient tension in the belt 30 may both secure the belt 30 to move with the drive roller 34 in rotation and control centering or tracking of the belt 30 on the drive roller 34 and tension idler 36.

A motor 38 and transmission 39 may power the drive roller 34. Typically, the tensioner 36 or tension idler 36 is not powered, except to the extent that the belt 30 is in frictional engagement therewithin. Nevertheless, a transmission 39 may change direction, speed, rate of rotation, direction, or torque to the drive roller 34 as appropriate. In fact, in certain sophisticated embodiments, the transmission 39 may even provide multiple “gearing” or ratios of speed of the motor 38 with respect to the speed (rpm) of the drive roller 34.

Ultimately, liquid waste, particulate matter, anything that may separate from the belt 30 and other related, stationary, or movable components, should collect to rest on a drain board 40 or pan 40 positioned on an underlying supporting surface 13. The pan 40 or drain board 40 may be configured in multiple components or pieces to more easily be more easily assembled onsite. The real difficulty may actually be handling comparatively thin, comparatively wide, and comparatively long drain boards 40.

Handling, moving, and storage are always considerations for solid objects. In the instant case, the drain board 40 has an aspect ratio of width to thickness of dozens if not hundreds. Meanwhile, the length with respect to the thickness of the drain board 40 may be on the order of many hundreds. Typically, for example, an enclosure 12 may be from about six feet wide and eight feet long or even three feet wide and five feet long to about ten feet square. One may think of a dog run, or dog holding pen, a single animal enclosure 12, to a horse stable as a typical size range. In fact, a system 10 in accordance with the invention may be a suitable pen 12 for fowl, including chickens, ducks, geese, and the like at a county fair, or horses at a rodeo or show. Thus, berths for such animals 24 or groups of such animals 24 may be the typical enclosures 12 serviced by the system 10.

Meanwhile, rubber, reinforced rubber, plastic, or other materials may constitute the structure of the pan 40 or drain board 40 in a comparatively small thickness aspect. Thickness may typically be from about one eighth to about one half inch. Three quarters inch or larger is possible, but typically not necessary. Therefore, a thickness of from about an eighth inch in a firm reinforced rubber, hard plastic (polymer), or reinforced plastic may suffice.

An elastomeric (e.g., rubber) composite may typically be on the order of one quarter to half an inch in thickness. In contrast, in a large pen 12 or enclosure 12, such as for an equine or bovine animal 24, width, length, or both may exceed eight or ten feet. Thus, these types of dimensions will basically define the aspect ratio of width to thickness, length to thickness, as well as length to width.

The sanitizer subsystem 16 may include a tank 42 containing a sanitizer, a detergent, or some other chemical combination suitable for scrubbing or otherwise cleaning a collection subsystem 14. Particularly, the belt 30 and standing surface 32 need it. Nevertheless, other supporting structures, such as the frame 26 and deck 28 may also require cleaning periodically. This will typically include the rollers 34, 36 and even the drain board 40 itself. To that end, surfactants, such as detergents, and the like may be contained or mixed in a tank 42.

Similarly, a tank 44 containing a rinse product may include plain water, chlorinated water, or even possibly water treated with another sanitizing agent. Thus, the tank 42 may include a sanitizer element, but often a rinse tank 44 will include some sanitizing element left as a residual antimicrobial or such on the components of the collection subsystem 14 rinsed.

To manage the use of the liquids in the tanks 42, 44 which may also be defined in terms of their liquids as a wash 42 and a rinse 44. Valves 46 may be selectively opened and closed to provide access to the tanks 42, 44 in order. Similarly, providing necessary pressure for spraying, a pump 48 may pump to a sprayer 50 through various lines 52 the liquids from the tanks 42, 44.

Similarly, lines 52 may distribute liquids from the tanks 42, 44 to individual sprayers 50. They 52 may extend through flexible lines 52 to a sprayer 50 movable between enclosures 12. A dedicated sprayer 50 may be associated with each enclosure 12 or each set of enclosures 12 in close proximity.

Ultimately, a function of the collection subsystem 14 and sanitizing subsystem 16 is to discharge any bedding or waste materials to the holding subsystem 18. To that end, a conveyor 54 may operate to carry solid materials. Typically, a conveyor 54 will include a tray 55 or channel 55 to contain solid waste, while a moving blade, cleat, scoop, or the like as a mover pushes solids or carries solids along the interior of the tray 55 toward some destination.

By the same token, a line 56 may carry a liquid or liquid constituents of wastes to a tank 58. More liquid is likely to be introduced into the collection subsystem 14 by the sanitizing subsystem 16, then any other mode. Thus, the tank 58 and line 56 may actually be dominated by the contents sprayed by the sprayer 50 from the tanks 42, 44.

Typically, the conveyor 54 will terminate at a bin 60 which may often be open, but need not be. That is, an open bin 60 having no cover may attract insects, discharge odors, and so forth. Accordingly, the bin 60 may be largely enclosed. Nevertheless, the bin 60 and the tank 58 may contain the solids and liquid, respectively, discharged by the collection subsystem 14.

A pump 62 may be required, if sufficient elevation descent is not available in the line 56. However, a pump 62 may be adapted or selected in accordance with the comparative geometry of the line 56, and the relationship between the collection subsystem 14 and the holding subsystem 18. In handling wastes, simple impellers, flexible impellers, and the like are more useful and more reliable, as well as more durable than positive displacement pumps such as diaphragm pumps, piston pumps, and the like.

Similarly, simple paddles, and the like may serve as a pump 62. Nevertheless, a pump 62 may be selected from one of many types. For example, waste products are often handled in sewer treatment plants by an eductor. This is a small, comparatively high speed jet of clean water injected by a pump 62 into a conduit and from thence into a channel carrying and from thence into a channel carrying a larger volume of slower moving waste liquid.

In this way, no actual component of a pump 62 is exposed to the chemical end precipitate difficulties within the waste products. A momentum transfer between the pumped, comparatively high speed jet of clean liquid such as water will impart sufficient momentum to keep the slower moving, larger volume flow of waste products moving.

A mechanical scrubber 64 may be appropriate for scrubbing a standing surface 32, or its basic belt 30. Typically, in one currently contemplated embodiment, a scraper 66 may provide mechanical force under pressure at a comparatively thin edge thereof. Urged against the standing surface 32, belt 30, or both the scraper 66 mechanically dislodges or otherwise disrupts solid materials or non-flowable materials from the standing surface 32 of the belt 30. Typical mechanisms may include metal blades 66, squeegee-type rubber scrapers 66, or the like.

Likewise, in addition, bristles of a brush 68, such as a roller brush 68 may also dislodge both solids and retained liquids on a standing surface 32 of a belt 30. A roller brush is a long, right, circular cylinder defined by bristles extending radially from a central axis or mandrel. That axle, mandrel, or rotor may contain bristles extending radially therefrom to scrub a surface as the axle rotates.

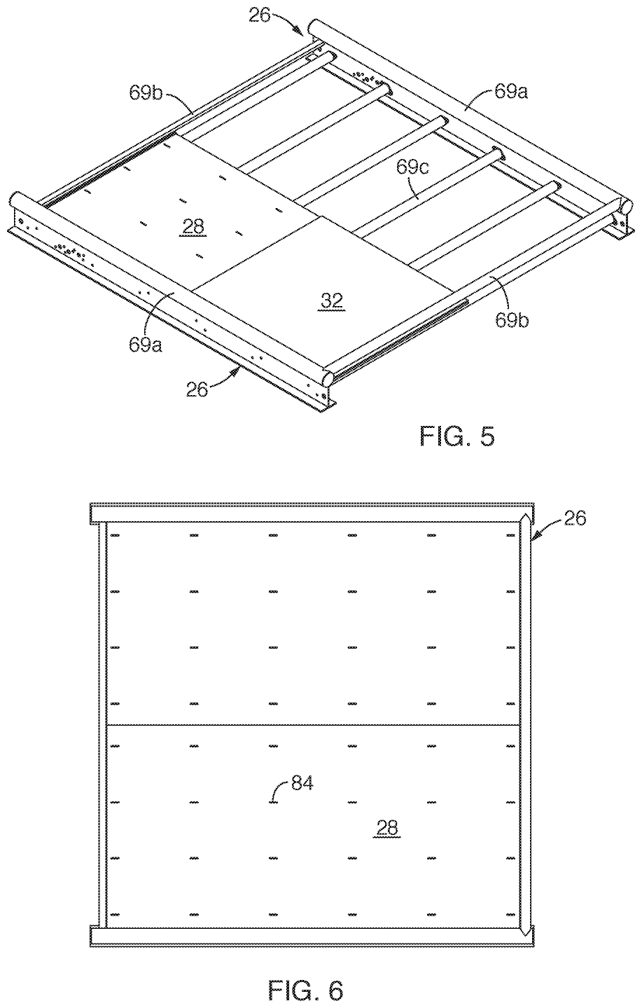

Referring to FIGS. 5 through 7, while continuing to refer generally to FIGS. 1 through 13, a frame 26 may include a various structural elements including, for example, side rails 69a as well as some type of end connectors 69b. Gussets, angle braces, or the like may be used as appropriate to stiffen the rectangular relationship required at corners between the side rails 69a and the end connectors 69b. In some embodiments, these components 69a, 69b may be welded together, or may be assembled onsite. Either approach has certain advantages.

Meanwhile, cross beams 69c may typically be tubular structures 69c either circular in cross section or rectangular in cross section. These provide stability between the side rails 69a, but also support directly a deck 28 supported thereon by the frame 26. In the illustrated embodiments, the deck 28 may underlie the standing surface 32, which typically is a part of the belt 30, but has several design criteria that may be met in alternative embodiments.

In the illustrated embodiment, the deck 28, the belt 30, especially including the standing surface 32 are all perforated with apertures 84. The apertures 84 may conduct liquids through the standing surface 32 and belt 30 as well as the deck 28. Thus, liquids may be percolated through the collection subsystem 14 in order to arrive at the drain board 40 constituting the bottommost element 40 thereof.

As discussed hereinabove, a drive roller 34 near a back fence 22 of the enclosure 12 drives the belt 30 and standing surface 32 to discharge into the holding subsystem 18 at the conveyor 54 and line 56. Meanwhile, the tension idler 36 or tail roller 36 is actually at the gate 20 side of the fence 22 of the enclosure 12.

Referring to FIG. 8, while continuing to refer generally to FIGS. 1 through 13, the layup or stack up of the collection subsystem 14 may include the cross beams 69c of the frame 26 underlying the deck 28. The deck 28 may be welded, bolted, or otherwise secured in place to be supported by the frame 26. A gap 70 may be no gap 70 at all. For example, the belt 30 that can be moved along the deck 28 needs to minimize friction of the belt 30 against the deck 28.

Also, for example, the gap 70 may include a friction-reducing material. Such a material may actually constitute the gap 70, permitting continuous, direct contact between the belt 30 and the sliding (bearing) material 70 operating as the gap 70. The gap 70 material may actually be accommodated by spraying it onto the deck 28, binding it to the deck 28, riveting, bolting, or otherwise securing it to the deck 28, depending upon the thickness of the gap material 70.

For example, high density polyethylene in a comparatively thin layer may provide a suitable reduction of the coefficient of friction between the belt 40 and the gap material 70. Nevertheless, the gap 70 constituent will best be secured to the deck 28. Thus, countersunk bolts, screws, machine screws, or the like may be used. Similarly, recesses to remove the profile of bolt heads, screw heads, rivet heads, and the like from contacting the belt 30 may be used in the gap 70 in order to provide fasteners into the deck 28.

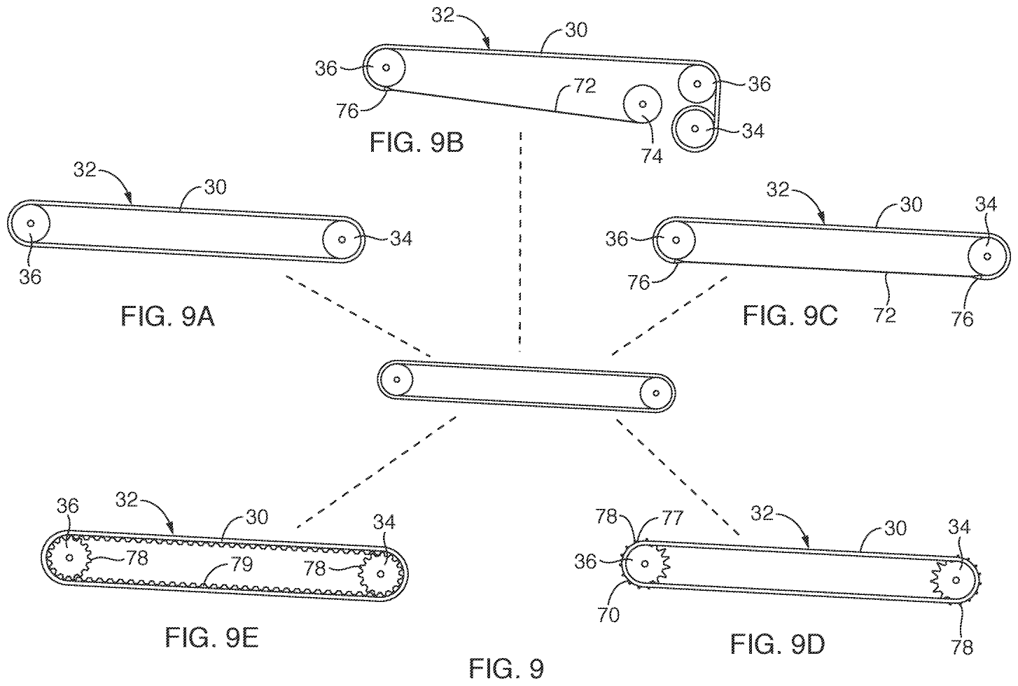

Referring to FIG. 9, including FIGS. 9A through 9E, a belt 30 may be driven in one of several suitable configurations or threading arrangements. A belt 30 may be an “infinite loop” or “endless loop” of a single material wrapped between the drive roller 34 and tension idler 36. Nevertheless, other connection schemes may be suitable and have different advantages.

Referring to FIG. 9A, a drive roller 34 and idler 36 operate on a belt 30 installed as an endless loop 30. In this embodiment, the entire belt 30 passes over the top of the driver roller 34 and idler 36, as well as underneath both. From a liquid disposition perspective, the belt 30 thus twice provides a barrier to liquid dropping through the belt 30 to arrive at the drain board 40.

Nevertheless, such a configuration is straightforward, rather simple, and has certain advantages such as installation, hand connection schemes, simplicity in number of components for rotation, and so forth. On the other hand, liquids may flow over open sides or other edges of the belt 30 as necessary. This may not necessarily require apertures 84 to work perfectly, or even be present. As seen hereinbelow, various configurations of the belt 30 may actually make perforations 84 in the belt 30 unnecessary.

Referring to FIG. 9B, a reciprocating belt 30 need not pass under the drive roller 34 and idler 36. For example, cables 72, such as round, wire rope, or flat polymeric belts 72 may connect by clamps 76 to the belt 30. In this way, the multiple idlers 36 may effectively guide the belt 30 as it is reciprocally moved back into position for collection, and forward for discharge. For example, a driver roller 34 operates as a collector drum 34 collecting the belt 30 as it passes forward in a discharge operation.

Meanwhile, the cable 72 or strap 72 may reciprocate the belt 30, drawing it from the collector drum 34 or drive roller 34. A cable reel 74 wraps it up or it takes it up to reposition the belt 30 in its collecting position. One advantage of such a mechanism is that the entire space under the belt 30 need not represent any significant obstruction to flow of liquids toward the drain board 40.

Referring to FIG. 9C, an endless belt 30 need not be composed entirely of the belt 30, itself, but may include cables 72 or straps 72 still operating as an endless loop. For example, the belt 30 may be registered (fitted, aligned) to extend from the drive roller 34 to the idler 36 for collection. Meanwhile, for cleaning and discharge, the rollers 34, 36 may advance the belt 30 toward discharging all waste products into the holding subsystem 18. Thereafter they return the belt 30, not by reciprocal motion, but by further advancement with the rollers 34, 36.

Referring to FIG. 9D, the belt 30 may be perforated, or otherwise provided with an engagement mechanism 77, such as apertures 77 for receiving teeth 78 of a sprocket. In the illustrated embodiment, edges of the belt 30 may be provided with stiffeners, such as wires, cables, rods (as in snowmobile and mini-excavator tracks), or the like to stabilize the apertures 77 in the belt 30. Teeth 78 of sprockets 34, 36 operating as the drive sprocket 34 and idler sprocket 36, act as drive roller 34 and idler 36, but toothed.

Referring to FIG. 9E, an alternative mechanism for providing teeth 78 on the rollers 34, 36 may involve teeth that do not necessarily engage apertures 77 through the belt 30. For example, a simple affirmative engagement mechanism may be teeth 78 on sprockets 34, 36 as rollers 34, 36, matched by a corrugated tooth pattern 79 on an interior surface of the belt 30.

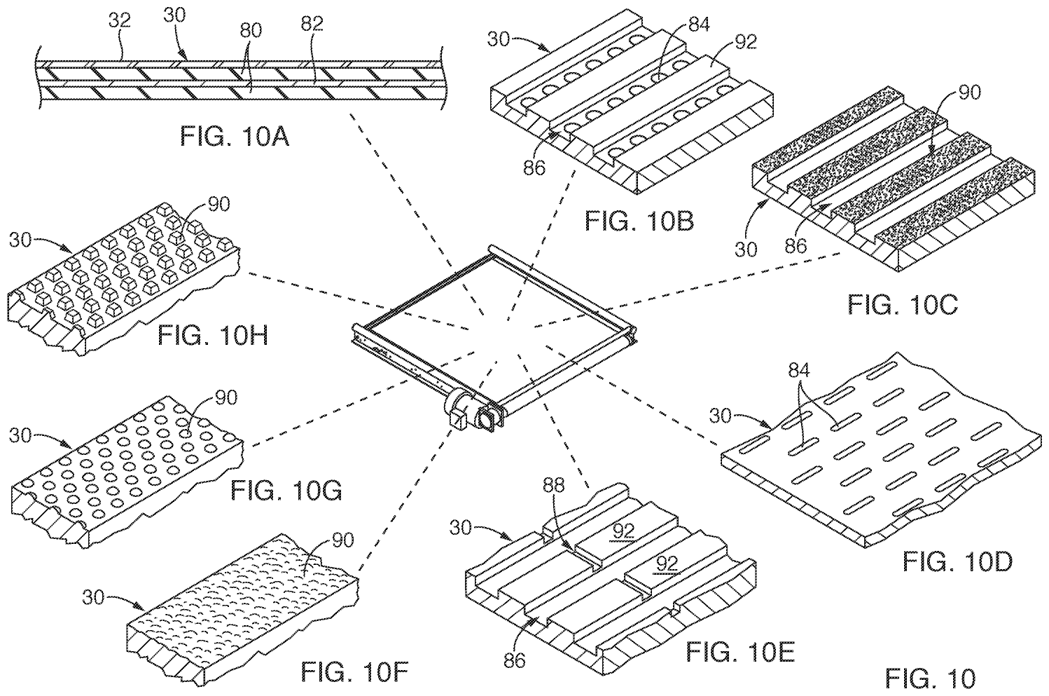

Referring to FIG. 10, various details of construction and configuration may be implemented in a belt 30 in accordance with the invention. Likewise, different mechanisms or means for providing a suitable standing surface 32 may be used. Accordingly, the subfigures, FIGS. 10A through 10H, illustrate certain configurations that may be considered for constructing the belt 30, a standing surface 32, or both.

For example, grit embedded in a surface 32 of a belt 30 or adhered thereto by an adherent such as a glue, paint, or the like may provide sufficient frictional engagement with an animal 24. The standing surface 32 needs to reduce sufficiently any tendency to slide along the belt 30. Similarly, surface texture, siping (cutting), or the like may be used.

Referring to FIG. 10A, a belt 30 may be constructed in certain currently contemplated embodiments as comprising a rubber layer 80 or elastomeric layer 80. In certain embodiments, extrusion, molding, or other processes may cure a resin of an elastomeric material 80 as one or more layers 80 embedding therewithin a mesh 82. Typically, elastomers have a property called “creep” meaning that under stress (load, force per unit area) they will deform permanently over time. Creep is actually a property of all amorphous materials, although insignificant with comparatively hardest materials such as glass. It is largely insignificant with structural metals such as iron, steels, and the like.

Nevertheless, in polymeric materials, long chain polymers are typically convoluted in their geometry. Permanent set, creep, may occur over time under load. Accordingly, for dimensional stability, an embedded mesh layer 82 may be formed of a stronger or stiffer polymer, a calendered one, or the like. Likewise, metals may be used, such as long metal fibers, screens, braids, and the like.

For example, radial tires include embedded within the rubber of the tire a mesh of steel. Thus, a belt 30 in accordance with the invention may be custom manufactured or purchased “off the shelf” to operate on the rollers 34, 36, and as a standing surface 32 or to support a standing surface 32.

In the illustrated embodiment of interest here, a surface mat 32 or a standing surface 32 may be constituted by a material different from that of the polymeric layers 80 of the belt 30. However, a separate material as a surface 32 need not be required. For example, texturing, certain patterning, and the like may provide frictional support for a foot, paw, or hoof, of an animal 24 thereon against slipping in a wetted environment.

Referring to FIG. 10B, in certain embodiments, the belt 30 may be provided with channels 86 Likewise, any embodiment of a belt 30 may include apertures 84 draining liquids through the belt 30. One may need to drain, eliminate, or dehydrate liquids that might otherwise reduce the friction between an animal 24 and the standing surface 32. In this illustrated example, for example, channels 86 are formed, alternating with lands 92. In this embodiment, apertures 84 may be located within channels 86. Channels 86 may collect, and direct to apertures 84, any liquids to be drained from the standing surface 32.

Again, the standing surface 32 need not be of a different material, but simply the top surface 32 of the belt 30. Nevertheless, in certain embodiments, it has been found useful to use fibers, having a higher coefficient of friction. Nevertheless, layering creates the risk of capillary action retaining liquids. Similarly, liquids tend to drain downhill but surface tension tends to retain them. Around crevices, corners, and small projections, surface tension may overcome the forces of gravity and inertia needed for drainage.

In such an embodiment as that of FIG. 10B, a continuous land 92, extending indefinitely or some comparatively large distance, may tend to become a slick surface. On the other hand, if a hoof compresses a land 92, then an adjacent, uncompressed land 92 may tend to provide a lateral stop as a wall beside the compressed land 92. To that extent, other embodiments, such as those of FIGS. 10E and 10H have certain advantages.

Referring to FIG. 10C, a channel 86 may be bordered by a land 92 having a textured top surface 32. Frictional engagement (low coefficient or friction with a foot, paw, hoof) maintains stability of an animal 24 on the standing surface 32. In this embodiment, no apertures 84 need be provided. In such an embodiment, liquids may simply be carried, typically by retention of surface tension, toward the same destination that the back side 69b of the deck 28. Thus, liquids may actually drain into the channels 86, but drain away in a level channel or tilted channel. Gravity or tilt angle will improve but may not be required.

On the other hand, in this currently contemplated embodiment, a slight declination in angle is helpful between the gate 20 and the back end 96. Such will provide immediate drainage of any bulk of liquid, while any retained liquid held in place by surface tension, debris, or the like is released in due course at the back end 69b of the system 10. In such an embodiment, the channels 86 reduce transport laterally (sideways) off the belt 30.

Referring to FIG. 10D, in certain embodiments, the belt 30 may be perforated with apertures 84. Apertures 84 may be elongated in the longitudinal direction of motion of the belt 30. Thus, as a practical matter, debris, chips, straw, and the like may pass through the apertures 84, thus resisting fouling or clogging. Likewise, one benefit of elongated apertures 84 is a larger area through which liquids may pass, while still maintaining a larger fraction of the width supporting the longitudinal forces of the drive roller 34 drawing the belt 30.

The standing surface 32 may be formed of the same material as that of the belt 30. The standing surface 32 may be textured with or homogenously molded (of the same material at the same time) as the belt 30 or the bulk of the belt 30.

Referring to FIG. 10E, the belt 30 may include channels 86 and cross channels 88. Such an environment or a configuration permits liquids to flow in any direction. An angle of tilt of the deck 28, but may subject liquids to the flow of gravity. A benefit of such a configuration is lands 92 and channels 86, 88 as texturing. Compression of weighted lands 92, contrasts with adjacent, unweighted, lands 92. The latter provide lateral restraint against sliding of a hoof, foot, paw, or the like. Texturing 90 on the lands 92 of the embodiment of FIG. 10E may further improve frictional engagement.

Referring to FIG. 10F, details peaks providing engagement locations and surfaces on the standing surface 32. Liquids have immediate escape from the peaks into valleys of the texturing 90. Liquids eventually move toward channels 86 for bulk carriage to elsewhere, and for removal.

Referring to FIG. 10G, an alternative embodiment for texturing 90 may be a regular pattern of raised texturing 90. Liquids escape to a lower level of the standing surface 32 of the belt 30.

Referring to FIG. 10H, an extreme configuration corresponding to that of FIG. 10E may involve a grid molded, cut, routed, applied, or otherwise formed as a standing surface 32 on the belt 30. In this embodiment, liquids have immediate recourse away from the protrusions 92 or lands 92, which are more particle-like in this embodiment. Liquids may discharge through apertures 84 in any embodiment or configuration of a belt 30 and standing surface 32.

Nevertheless, in certain embodiments, benefits exist to draining liquids away, while not relying on draining through the belt 30. For example, draining liquids through the belt 30 on a top portion of the loop in FIG. 9A and the bottom portion of the loop doubles the resistance to drainage and requires additional cleaning time and so forth. Cleaning raises additional problems.

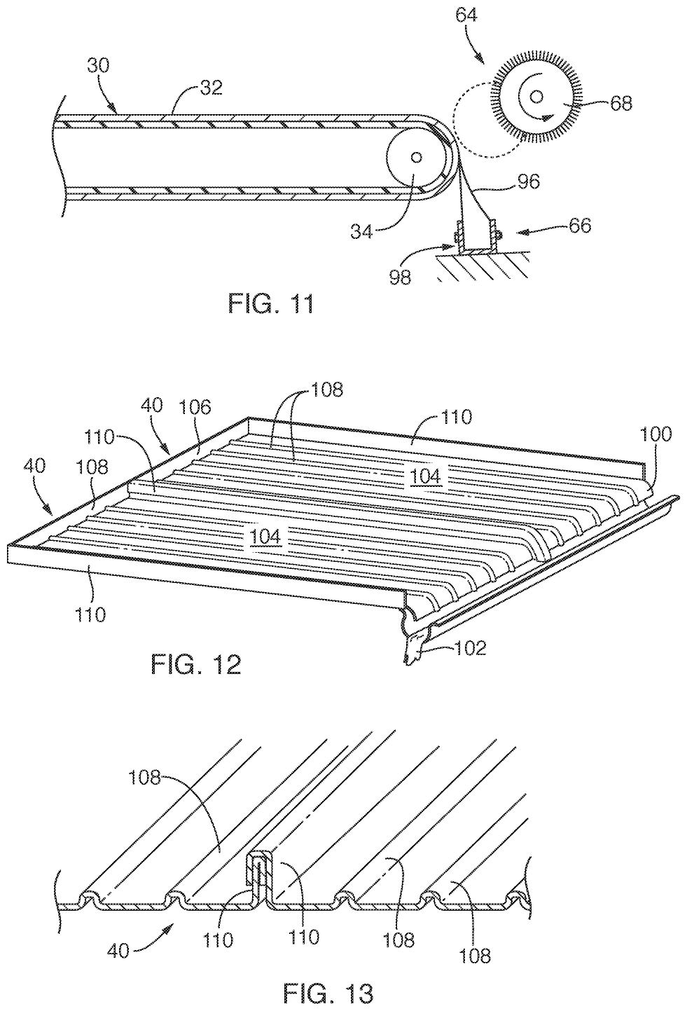

Referring to FIG. 11, while continuing to refer generally to FIGS. 1 through 13, removal of waste, including both solids and liquids from a belt 30 may include removal equipment 66, 68. A scraper 66 riding against the standing surface 32 of a belt 30, a roller brush 68 or simply a brush 68 of any suitable type, or both dislodge waste. In the illustrated embodiment, the scraper 66 may be a blade 96 configured of metal, a stiff polymer such as a hard plastic, or a softer polymer, such as an elastomeric polymer. The blade 96 may actually be a squeegee 96, flexible, capable of applying pressure, but capable of maintaining maximum contact.

On the other hand, a certain amount of compression or force is applied by a metal blade 96 as a scraper 66 against a standing surface 32 of a belt 30. The roller 34 acts as an anvil against which the blade 96 may compress the belt 30 and standing surface 32. This improves removal of collected solid materials, and liquids for that matter.

The brush 68 may operate (rotate) on an axle. It may permanently contact the belt 30 or selectively engage the belt 30. It is contemplated that a brush 68 in the illustrated embodiment should rotate counter clockwise. That is the same “linear” direction of movement as the belt 30 and drive roller 34 (rotating clockwise). In such an embodiment, the brush 68 should typically operate at a higher speed (linear speed, radius times angular velocity) greater than that of the roller 34 and belt 30. In this way, the bristles of the brush 68 drive waste product and liquids in the same direction as the scraper 66.

Similarly, a mount 98 may be designed to pivot under a bias urging the blade 96 against the belt 30 circulating around the drive roller 34. A benefit to a pivot and bias is that an abnormality, such as a connector in the belt may pass by pushing the scraper 66 away. The blade 66 springs away, around the obstruction, until it passes, immediately biasing back against the belt 30 with the appropriate strength or force.

Referring to FIGS. 12 and 13, while continuing to refer generally to FIGS. 1 through 13, the drain board 40 or pan 40 may be formed in a single, integrated piece, or in modular pieces. For example, in the illustrated embodiment, the pan 40 or tray 40 acting as a drain board 40 for liquids may include a drip edge 100. A terminal end or downstream end is located near the back edge 69b of the frame 26 and the deck 28.

In the illustrated embodiment, the tray 40 is constituted by multiple trays 40. Each terminates in a drip edge 100 draining into a gutter 102. The gutter 102 operates as the initial stage of the line 56 draining liquids into a holding tank 58. A floor 104 of the drain board 40 may actually be corrugated as stiffening. For example, a back wall 106 and corrugations 108 resist flow of liquids across them. Both increase the section modulus of the floor 104.

For example, section modulus is a mechanical property of shape of solid materials in a bending mode. Section modulus, as a mechanical property, represents a mathematical integration of the amount of material or cross section of material integrated over its distance from a neutral axis. At a neutral axis or plane there is no compression nor tension. Bending, typically, a beam-like material loaded from the top, causes compression above the neutral axis, and tension below, all in the same solid piece of material. Section modulus is improved by moving more of the material or forming a solid cross section with more of its net material away from the neutral axis, toward the maximum dimension (outermost fiber).

In the embodiment of FIG. 12, the corrugations 108 put more material farther from the neutral axis near the vertical center of the floor 104 of the drain board 40. Accordingly, the corrugations 108 themselves also tend to provide part of the containment by directing liquids toward the drip edge 100. They represent a resistance to flow in a lateral direction across the corrugations 108.

For example, the overlapped ultimate side walls 110 are interleaved to provide both stiffening (increase of section modulus) and a wall 110 resisting passage of liquids. Assembling several modular drain boards 40 permits a length considerably longer than their width. Here, length corresponds to the longitudinal direction of movement of the belt 30. Thus, a number of the drain boards 40 may be assembled with overlapping or interleaved side walls 110. Handling is greatly improved as well as storage.

Corrugations 108 may be sized along with the thickness of the material in the floor 104 to provide sufficient stiffness for handling. Several single drain boards 40 make up the drain board assembly 40 under the rest of the collection subsystem 14.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
providing an enclosure, the enclosure supportable independently on a supporting surface;
providing a frame fitted to a temporary enclosure structured to be readily transportable, erectable, and removable, as a temporary structure confining an animal, the frame and enclosure each being self supportable independently on a supporting surface;
providing a deck supported by the frame;
providing a surface, selectively movable horizontally with respect to the deck and supported thereby in a vertical direction;
selecting a first location at which the temporary enclosure stands in operable relation to a transport structure having a mechanism effective to receive from the surface, and carry to a temporary storage, solids and liquids received from the surface upon movement of the surface with respect to the deck;
positioning at least a portion of each of the frame, deck, and surface in the temporary enclosure and in operable relation with the transport structure;
placing an animal within the enclosure;
discharging solid materials from the surface by moving the surface toward the transport structure; and
removing the animal, frame, deck, and surface from the first location.

2. The method of claim 1, comprising relocating the frame, deck, and surface to a second location remote from the first location.

3. The method of claim 1, comprising removing from proximate the first location the temporary storage receiving the solid waste.

4. The method of claim 1, comprising providing a drain pan under the surface, shaped to collect and drain liquids from the surface toward the transport structure.

5. The method of claim 4, comprising removing a tank as at least a portion of the temporary storage, after receiving therein the liquids received from the surface and drain pan.

6. The method of claim 1, comprising dislodging solid materials from the surface by moving the surface horizontally toward the transport structure and immediately away therefrom.

7. The method of claim 1, comprising inverting the surface before moving it immediately away from the transport structure.

8. The method of claim 1, comprising placing, on the surface, bedding materials selected for the animal.

9. The method of claim 1, comprising providing a motor and controller operably connected to move the surface.

10. The method of claim 9, comprising:
providing the surface as an endless belt;
providing a drive roller operably connected to drive the endless belt and driven by the motor;
providing a scraper operably positioned to dislodge a portion of the solid materials from the surface; and
dislodging another portion of the material from the surface by washing the surface with a washing liquid.

11. An apparatus comprising:
a frame fitted to an enclosure readily transportable, erectable, and removable, as a temporary structure confining an animal, the frame and enclosure each being self-supportable independently on a supporting surface;
a deck supported by the frame;
a surface, selectively movable horizontally with respect to the deck and supported thereby in a vertical direction;
a transport structure proximate the enclosure having a mechanism effective to receive from the surface, and carry to a container for temporary storage, solids and liquids received from the surface upon movement of the surface with respect to the deck; and
storage operably and temporarily connectable and disconnectable, selectively, to the transport structure to receive therefrom the solids and liquids.

12. The apparatus of claim 11, comprising a drain pan under the surface, shaped to collect and drain the liquids from the surface toward the transport structure.

13. The apparatus of claim 12, wherein the storage comprises a storage tank receiving therein the liquids received from the surface and drain pan.

14. The apparatus of claim 11, comprising a dislodging device dislodging at least a portion of the solids from the surface by moving the surface horizontally toward the transport structure.

15. The apparatus of claim 14, comprising a roller inverting the surface before moving it immediately away from the transport structure.

16. The apparatus of claim 15, comprising a motor and controller operably connected to move the roller.

17. The apparatus of claim 16, wherein the surface constitutes a feature of an endless belt.

18. The apparatus of claim 11, comprising:
a scraper operably positioned to dislodge a portion of the material from the surface; and
a washing system operably connected to wash the surface with a washing liquid.

19. A method comprising:
providing an enclosure, readily transportable, erectable, and removable, as a temporary structure confining an animal, the enclosure supportable independently on a supporting surface;
providing a frame fitted to the enclosure and supportable independently on the supporting surface;
providing a deck supported by the frame;
providing a surface configured as a belt operably movable by a roller to be selectively movable horizontally with respect to the deck and supported thereby in a vertical direction;
providing a drain pan under the surface to receive therefrom liquids;
providing a transport structure proximate the enclosure having a mechanism effective to receive from the surface, and carry to a temporary storage location, solids and the liquids received from the surface in response to movement of the surface with respect to the deck;
selecting a first location;
positioning the enclosure, frame, deck, surface, and transport structure on the supporting surface at the location;
placing an animal within the enclosure;
discharging solid materials from the surface by moving the surface toward the transport structure;
removing the frame, deck, surface, and transport structure from the first location;
relocating the frame, deck, surface, and transport structure to a second location remote from the first location; and
continuing to operate the method.

20. The method of claim 19, comprising:
providing a motor and controller operably connected to move the surface as an endless belt;
providing a drive roller operably connected to drive the endless belt and be driven by the motor;
placing, on the surface, bedding materials selected for the animal
removing a storage bin receiving from the transport structure solid waste;
removing a storage tank after receiving therein the liquids received from the surface and drain pan;
dislodging a portion of the solid materials from the surface by moving the surface horizontally toward the transport structure and immediately away therefrom by inverting the surface before moving it immediately away from the transport structure;
providing a scraper operably positioned to dislodge a portion of the material from the surface; and
dislodging another portion of the material from the surface by washing the surface with a washing liquid.
